(19) United States
(12) Patent Application Publication
(10) Pub. No.: US 2009/0062059 A1
(43) Pub. Date: Mar. 5, 2009

(54) Boosting assist hydraulic hybrid combination

(75) Inventor: John Shutty, Clarkston, MI (US)

Correspondence Address: WARN, HOFFMANN, MILLER & LALONE, .P.C, PO BOX 70098, ROCHESTER HILLS, MI, 48307, US

(73) Assignee: BorgWarner Inc., Auburn Hills, MI (US)

(21) Appl. No.: 12/229,924

(22) Filed: Aug. 28, 2008

Related U.S. Application Data
(60) Provisional application No. 60/966,828, filed on Aug. 30, 2007.

(51) Int. Cl. B60K 6/08

(52) U.S. Cl. 477/2

(57) ABSTRACT

A hydraulic hybrid system having an internal combustion engine and a hydraulic motor where the hydraulic hybrid system includes a boost device and at least one hydraulic storage device. The boost device is operatively connected to the internal combustion engine. The at least one hydraulic storage device is in operative fluid communication with the boost device and the hydraulic motor for selectively providing power by way of a controller to the hydraulic motor, the boost device, and the internal combustion engine under predetermined operator demand conditions.

### CROSS-REFERENCE TO RELATED APPLICATIONS

This application claims the benefit of U.S. Provisional Application No. 60/966,828, filed Aug. 30, 2007. The disclosure of the above application is incorporated herein by reference.

### FIELD OF THE INVENTION

The present invention relates to the use of hydraulic energy in a hybrid hydraulic/internal combustion engine system.

### BACKGROUND OF THE INVENTION

Due to regulations and customer demands it is ideal to improve fuel economy and reduce emissions produced by internal combustion engines. One way of increasing the efficiency of the internal combustion engine is to include an electric hybrid power which assists the engine. While electric hybrid systems are more common, hydraulically powered systems can also be used for providing power to a hydraulic motor and internal combustion engine hybrid system.

The goal in any hybrid system is efficient storage and use of power. Efficient storage and use of power, allows smaller IC engines to be utilized. This provides advantages in both fuel economy and weight.

Therefore, it is desirable to develop a hydraulic energy system which advantageously uses hydraulic power for maximizing efficient use of same when powering a vehicle or other hybrid powered machine.

### SUMMARY OF THE INVENTION

The present invention relates to a method of using hydraulic energy in a hydraulic hybrid system having an internal combustion (hereinafter “(IC)”) engine and a hydraulic motor. The internal combustion engine of the hydraulic hybrid system includes a hydraulically powered boost device and at least one hydraulic storage device. The boost device is operatively connected to the IC engine for improving power output of the IC engine. The at least one hydraulic storage device is in operative fluid communication with the boost device and the hybrid system for selectively providing power to at least one of the boost device and the hydraulic motor under predetermined conditions.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a hydraulic hybrid system having a boost device in accordance with an embodiment of the present invention;

FIG. 2 is a schematic view of a hydraulic hybrid system having a boost device in series with a turbocharger assembly in accordance with an embodiment of the present invention;

FIG. 3 is a schematic view of a hydraulic hybrid system having a boost device in parallel with a turbocharger assembly in accordance with an embodiment of the present invention; and

FIG. 4 is a flow chart of a method for controlling a hydraulic hybrid system in accordance with an embodiment of the present hybrid power plant invention.

### DETAILED DESCRIPTION OF THE PREFERRED EMBODIMENTS

The following description of the preferred embodiment(s) is merely exemplary in nature and is in no way intended to limit the invention, its application, or uses.

Provided in the present invention is a hydraulic method for use of hydraulic energy in a hydraulic hybrid system. The method comprises the steps of: providing a hydraulic hybrid system, determining whether hydraulic energy is stored and at what level, and based on operational conditions, apportioning the energy where it is most efficient for performance on the vehicle.

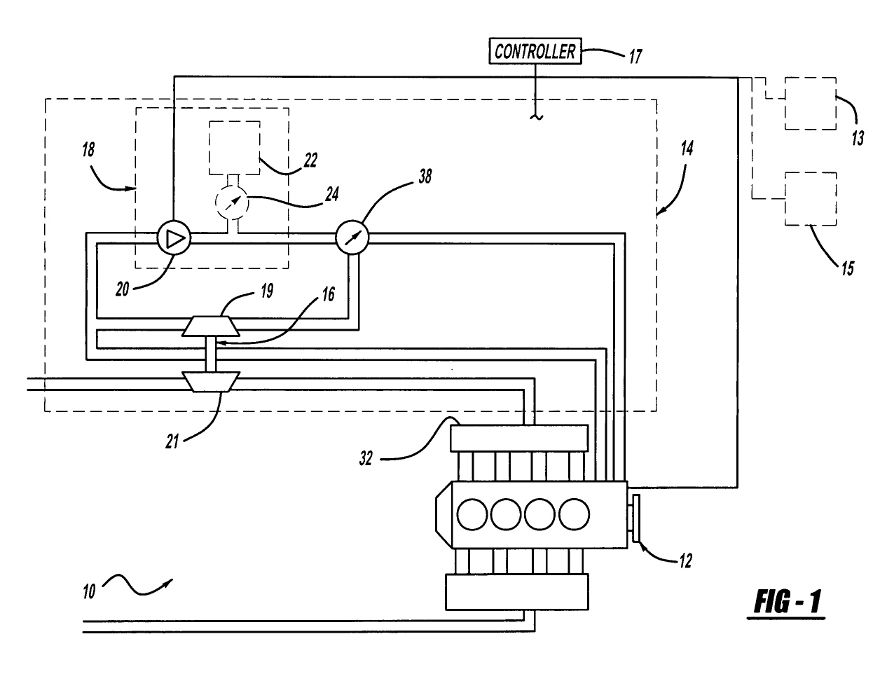

In the method of the present invention, referring to FIGS. 1-3, a hydraulic hybrid system is provided which is generally shown at 10. The hydraulic hybrid system 10 has a hybrid power plant generally indicated at 12. Hybrid power plant 12 includes a hydraulic motor portion and an IC motor engine. A boost assembly generally indicated at 14 is operatively connected to the IC engine of the hybrid power plant 12. The boost assembly 14 includes a boost device generally indicated at 16 and at least one hydraulic storage system 18. The hydraulic storage system 18 is in operative fluid communication with the boost device 16 and the hydraulic motor of hybrid power plant 12 for selectively providing power to the boost device 16 for the IC engine, the hydraulic motor, or a combination thereof under predetermined conditions. A controller 17 is used for monitoring operator demands and the hydraulic energy stored in the hydraulic storage system and controlling where hydraulic energy is used during operation. By way of explanation and not limitation, the hydraulic storage system 18 is charged from: the IC engine during operation; a transmission assembly 13 (shown in phantom); a braking assembly 15 (shown in phantom) under braking conditions, or combinations of these. This transfer of energy may be via hydraulic, electrical or mechanical link.

By way of explanation and not limitation, the boost device 16 includes a hydraulic turbine 19 coupled to a compressor 21 for rotating the compressor 21 in response to hydraulic fluid actuation. Thus, as hydraulic fluid flows from the hydraulic storage system 18 to the hydraulic turbine 19, the hydraulic turbine 19 rotates which causes the compressor 21 to rotate. The compressor 21 compresses gaseous fluid which ultimately flows to the IC engine for improving power and performance of the IC engine, as described in greater detail below.

As shown in FIG. 1, the hydraulic storage system 18 includes a pump 20. Thus, the pump 20 causes hydraulic fluid to flow to the hydraulic motor of hybrid power plant 12, the boost device 16, or a combination thereof under predetermined conditions and the hydraulic fluid is stored in a tank or reservoir 23. In a preferred embodiment, the hydraulic storage system 18 also includes an accumulator 22 which is in operative fluid communication with the pump 20. The hydraulic storage system 18 can also include an accumulator valve 24 which controls the flow of hydraulic fluid into and out of the accumulator 22. Thus, if the accumulator valve 24 is open and the pressure downstream of the accumulator valve 24 is greater than the upstream pressure, the pump charges the accumulator 22 by pumping hydraulic fluid into the accumulator 22. Additionally, if the accumulator valve 24 is open and the pressure downstream of the accumulator valve 24 is less than the upstream pressure, the accumulator 22 can discharge the hydraulic fluid and power the hydraulic motor, the boost device 16, or a combination thereof.

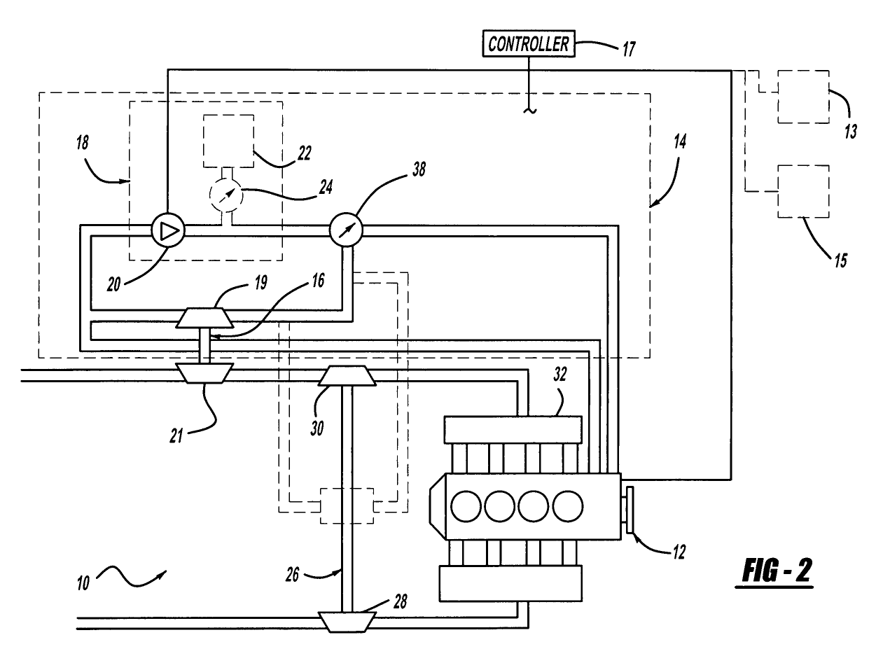

An alternate embodiment shown in FIG. 2 includes a turbocharger assembly generally indicated at 26 which has at least a turbine 28 and a compressor 30. The turbine 28 and compressor 30 are moveably coupled to one another. The compressor 30 is in operative fluid communication with an intake 32 of the IC engine. The boost device 16 is upstream of and in series with the compressor 30. It should be appreciated that the boost device 16 can also be plumbed out of the main stream flow path but in series with the compressor 30, and alternatively includes a valve so that gaseous fluid can flow through the boost device 16, directly to the intake 32, or a combination thereof.

A bypass valve 25 is provided. The bypass valve 25 is open when boost device 16 is not in operation and the engine is operating under high load conditions. During boost assist the valve 25 is selected to be closed or partially closed.

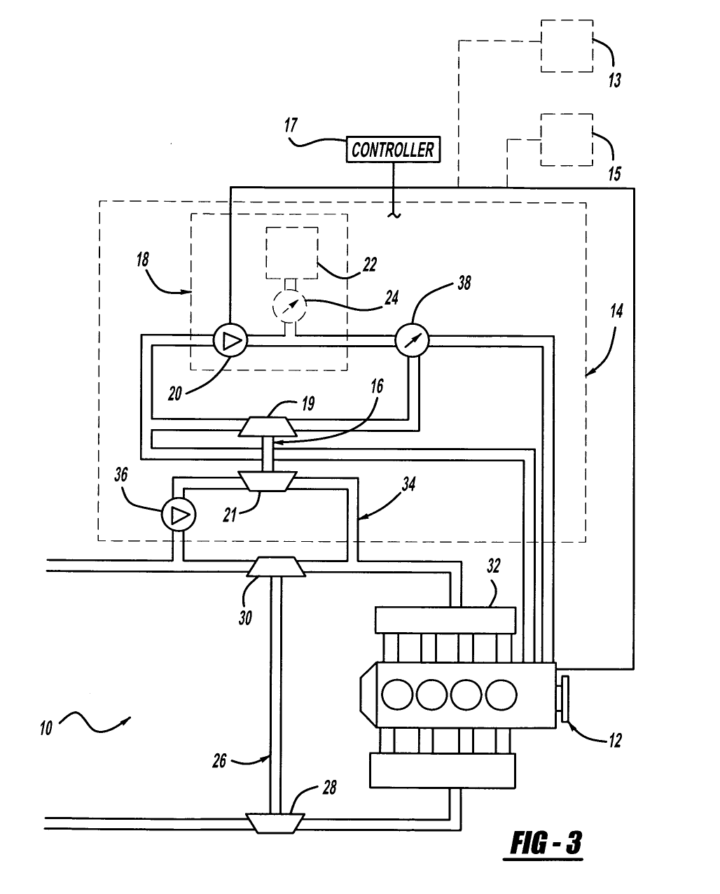

Alternatively, as shown in FIG. 3, the boost device 16 can be in parallel with the compressor 30, such that the boost device 16 is in operative fluid communication with the intake 32 and the gaseous fluid that passes through the boost device 16 bypasses the compressor 30. A bypass channel, generally indicated at 34, includes a three way valve 36 in order to control the flow of gaseous fluid to the boost device 16 and the compressor 30.

The valve 36 is operated to block off flow to the compressor 30 but allow flow from the booster into the intake 32. This prevents back flow into the compressor 30 and ultimately out the air filter of the engine, if the booster is being used without the turbocharger. Alternatively the valve 36 is actuated to stop reverse airflow to the booster and out through the air filter. The valve 36 is also positionable to allow airflow from both the compressor 30 and the booster into the intake when both are operational.

The hydraulic storage system 18 flows hydraulic fluid to the hydraulic motor of hybrid power plant 12, the boost device 16, or a combination thereof. A boost assembly valve 38 controls the flow of hydraulic fluid from the hydraulic storage device to the hydraulic motor of hybrid power plant 12, boost device 16, or combination thereof. Whether the hydraulic fluid flows to the hydraulic motor of the hybrid power plant 12 or the boost device 16, the hydraulic fluid returns to the hydraulic storage system 18. It should be appreciated that the boost device valve 38 can also be used to modulate the power or flow of hydraulic fluid from the hydraulic storage device to the hybrid power plant 12 and boost device 16.

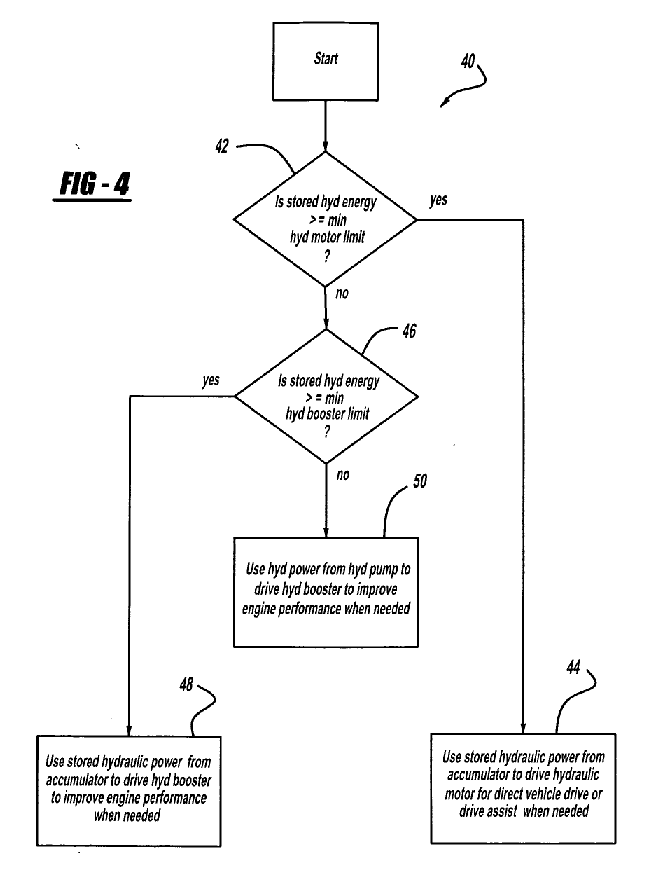

In reference to FIG. 4, a method as used in a controller for controlling the hydraulic hybrid system 10 having an IC engine is generally shown at 40. At decision box 42 it is determined if the hydraulic energy in the hydraulic storage system 18 is greater than or equal to a predetermined minimum hydraulic motor limit. If there is a predetermined minimum which the controller determines allows use of the hydraulic motor, the method proceeds to decision box 44 and the hydraulic motor is used for powering the vehicle in high demand or start up conditions. If the energy level in the hydraulic storage system 18 is below the minimum storage value, then the method 40 proceeds to decision box 46. In decision box 46 the controller assesses whether the stored hydraulic energy is greater than or equal to the predetermined minimum which allows at least one, but preferably many, boost operating cycles. If this minimum is met the controller at box 48 directs hydraulic power from the hydraulic storage device (accumulator) to drive the IC engine booster for improving performance when operation demands. Any of the minimum storage values discussed above can be a predetermined value that is not necessarily a value when the hydraulic storage device 18 does not have any energy, but instead can be a predetermined value when the hydraulic storage system 18 will not perform as desired or when conservation of hydraulic energy is desired.

The predetermined values may be preset values based on known vehicle weight, operating conditions and vehicle parameters. It is also within the scope of the present invention that the predetermined minimums may be modified, adjusted or recalculated during operation based on operating conditions such as: learned operator tendencies or inputs, environmental operating factors, such as hilly conditions or city versus highway driving or even sensed changes in vehicle weight.

If in decision box 46 it is determined that the energy level in the hydraulic storage system 18 is below the required minimum storage value for driving the booster, the method 40 proceeds to decision box 50 and the internal combustion engine is used to drive the hydraulic pump which drives the hydraulic booster for improving engine performance.

As an example of a method for recharging the hydraulic system, the following is given, it is determined if the IC engine is operating under low energy demand conditions. First, by way explanation and not limitation, the IC engine operates under low energy demand conditions when the IC engine is idling, operating under low load steady state conditions, or the like. If it is determined that the IC engine is operating under low energy demand conditions, the hydraulic storage device is charged. The hydraulic storage system 18 is charged when the IC engine is operating under low energy demand conditions because the energy that would be used to charge the energy storage device is not being required by the operator such that energy can be provided without loss of performance to the operator. By way of explanation and not limitation, the hydraulic storage system 18 can be charged by the IC engine, during braking by the transmission, brake system, or the like. Thus, the hydraulic hybrid system 10 stores energy that the IC engine produces which is not otherwise used and uses it at other times to operate the hybrid power plant 12 more efficiently. When the hydraulic storage system 18 is being charged, the pump 20 is using power to pump hydraulic fluid which is stored in the accumulator 22.

If it is determined that the IC engine is not operating under low energy demand conditions, it is determined whether the IC engine is operating under acceleration conditions. By way of explanation and not limitation, the IC engine is operating under acceleration conditions when the vehicle is accelerating, the hybrid power plant 12 RPMs are increasing, or the like. If it is determined that the hybrid power plant 12 is operating under acceleration conditions, the hydraulic storage system 18 provides power to the hydraulic hybrid power plant 12 as required.

By way of explanation and not limitation, the IC engine is operating under high energy demand conditions when the IC engine must produce a greater amount of power than that required under normal acceleration conditions where IC boost is desired. This value can be a predetermined value based upon the operation of the vehicle or a sensed condition based on user input. If it is determined that the IC engine is operating under high energy demand conditions, the boost device provides power to the booster device 16 of the IC engine. When boost device 16 provides power to the IC engine, the hydraulic storage system 18 powers the boost device 16 with hydraulic power, and the boost device provides additional compressed gaseous fluid so that the IC engine can perform the necessary power more efficiently when compared to if the boost device 16 did not provide additional power to the IC engine.

Thus, in operation the hydraulic power management system of the present invention preferentially uses powering of the hydraulic motor for launch of the vehicle. When the hydraulic power reserve is depleted to a predetermined level from repeated launch of vehicle using the hydraulic motor, and there is a lack of sufficient opportunities for replenishing, a hydraulic power reserve mode is used to facilitate conservation of the remaining hydraulic power. In this mode, a fraction of the normal hydraulic power, which would normally be used for using the hydraulic motor, is cycled to the boost device 16 of the IC engine. The boosted IC engine is then used for initial launch. This allows hydraulic assist of the booster to be used for a number of additional launches even if no additional charging of the system occurs. There is also a fail safe mode if substantially all the hydraulic reserves are depleted. In the fail safe mode, the hydraulic pump is used for powering the booster. While this mode is not preferred, it still provides improved performance, but to the detriment of more fuel consumption.

This system allows for efficient use of hydraulic power to provide the best performance for launch of the vehicle when sufficient minimum resources in the hydraulic storage system, for instance, greater than or equal to 50% capacity. If the stored hydraulic power is less than the predetermined minimum, for instance, less than 50%, the system uses the next most efficient use of power which is using hydraulic power to provide boost for the internal combustion engine and use the boosted engine for startups. This allows improved startup performance yet conserves hydraulic energy since many more startups can be accomplished using less hydraulic energy than using the hydraulic motor of the power plant.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of using hydraulic power in an operator controlled hybrid hydraulic liquid power system for a machine comprising:
a) providing a hydraulic motor coupled for powering a machine; a source of stored hydraulic energy, a hydraulic pump; and an internal combustion engine having a hydraulically operated booster; which are operably coupled for driving a machine with hydraulic power, internal combustion power, or both;
b) providing a controller for selectively controlling hydraulic energy use depending on sensed operator demands and sensed available hydraulic resources;
c) said controller selectively first using stored hydraulic energy for operation of the hydraulic motor if sufficient stored energy is available;
d) said controller selectively secondarily using hydraulic energy for boosting the internal combustion engine if stored hydraulic energy is below a predetermined level in order to conserve hydraulic energy; and
e) said controller selectively using the hydraulic pump to power the booster during conditions of lack of sufficient stored hydraulic energy for powering the hydraulic motor or booster with stored energy.

2. The method of claim 1, wherein using stored hydraulic power for powering the hydraulic motor is preferentially used during start up and high demand acceleration conditions.

3. The method of claim 1, wherein the step of selectively secondarily using hydraulic energy further comprises using a plurality of fractions of stored hydraulic power when the source of stored hydraulic energy is below a predetermined hydraulic storage level for powering the booster while running the internal combustion engine.

4. The method of claim 3, wherein the internal combustion engine and the booster are used for powering of a vehicle during launches or other high demand conditions.

5. The method of claim 1, wherein when said source of stored hydraulic energy is below a minimum which allows direct powering of the hydraulic motor or the booster, the controller selects the hydraulic pump and internal combustion engine during start up conditions.

6. The method of claim 6, wherein in step e the hydraulic pump powers the booster of the internal combustion engine during start up conditions, light demand conditions, and other conditions designated by the controller.

7. The method of claim 7, wherein the internal combustion engine is used for powering the pump.

8. The method of claim 1, wherein the system is used in powering a vehicle.

9. The method of claim 1 wherein the hydraulic storage is replenished during braking, from the transmission or the internal combustion engine running the hydraulic pump.

10. The method of claim 9, wherein the levels of sufficient stored energy of step 2 and predetermined level of step d are selected and modified based on operating conditions.

11. A hydraulic hybrid system for a vehicle having an internal combustion engine and a hydraulic motor, said hydraulic hybrid system comprising:
a hydraulically powered boost device operatively connected to said engine for providing boost to said engine; and
a hydraulic storage device in operative fluid communication with said boost device and said hydraulic motor; and a controller for assessing stored hydraulic power and operation demands and for selectively providing power to said boost device, said hydraulic motor, said internal combustion engine, said engine under predetermined conditions, and combinations thereof.

12. The hydraulic hybrid system of claim 11, wherein when stored hydraulic energy in the hydraulic storage device is greater than a first predetermined level, the controller directs hydraulic power to the hydraulic motor upon predetermined operator high demand conditions.

13. The hydraulic hybrid system of claim 12, wherein when stored hydraulic energy in the hydraulic storage device is less than said first predetermined value but greater than a second predetermined minimum, the controller directs hydraulic power to the booster of the internal combustion engine.

14. The hydraulic hybrid system of claim 13, wherein said first predetermined level and a said second predetermined minimum are selected and modified based on operating conditions.

15. The hydraulic hybrid system of claim 12 further comprising a hydraulic pump coupled for powering said booster; said controller using said pump for powering said booster when said hydraulic storage is below said second predetermined minimum.

16. The hydraulic hybrid system of claim 14, wherein said pump is powered by said internal combustion engine.

17. The hydraulic hybrid system of claim 14, wherein the hydraulic power remaining below said first predetermined level and above said second predetermined level includes enough hydraulic energy for several applications of boost during high energy demand conditions.

18. The hydraulic hybrid system of claim 11, wherein said hydraulic storage device is charged when said engine is operating under low energy demand conditions by one of a group consisting of:
said engine;
a transmission assembly; and
a braking assembly.

19. The hydraulic hybrid system of claim 11, wherein said hydraulic storage device is a pump.

20. The hydraulic hybrid system of claim 11, wherein said hydraulic storage device is a pump in operative fluid communication with an accumulator.

21. The hydraulic hybrid system of claim 11 further comprising a turbocharger assembly having at least a turbine and a compressor moveably coupled to one another, wherein said compressor is in operative fluid communication with an intake of said engine.

22. The hydraulic hybrid system of claim 21, wherein said boost device is upstream of said compressor.

23. The hydraulic hybrid system of claim 21, wherein said boost device is in parallel with said compressor and in operative fluid communication with said intake of said engine

24. The hydraulic hybrid system of claim 21, wherein said boost device is operably connected to a shaft that moveably couples said compressor and said turbine in said turbocharger assembly.

25. The hydraulic hybrid system of claim 11, wherein said boost device is in direct operative fluid communication with an intake of said engine.

26. The hydraulic hybrid system of claim 12, wherein said hydraulic storage device provides power to said hydraulic motor when said hydraulic hybrid system is operating under acceleration conditions.

27. The hydraulic hybrid system of claim 12, wherein said hydraulic storage device provides power to said boost device when said engine is operating under high energy demand conditions and the storage capacity is below a first predetermined level and above a second predetermined level.
